(19) United States
(12) Patent Application Publication
(10) Pub. No.: US 2006/0059656 A1
(43) Pub. Date: Mar. 23, 2006

(54) Castor

(76) Inventor: David Hackett, Salford (GB)

Correspondence Address: Kane, P.O. Box 6534, Grand Rapids, MI, 49516-6534, US

(21) Appl. No.: 10/532,443

(22) PCT Filed: Oct. 23, 2003
(86) PCT No.: PCT/GB03/04569

§ 371 Date: Apr. 23, 2005

(30) Foreign Application Priority Data
Oct. 23, 2002 (GB) 0224644.5

(51) Int. Cl. B60B 33/00

(52) U.S. Cl. 16/20

(57) ABSTRACT

A castor for shopping and hospital trolleys which provides enhanced steering and manoeuvrability of the trolley, wherein a fork (13) of the castor is freely rotatable on a first bearing (15) with respect to a first member (16) connected to the fork (13), while the first member (16) is also freely rotatable on a second bearing (20) with respect to a second member (21) connected to the first member by a bolt (17). The second member may be connected to a frame or chassis (24) of a load bearing object such as a trolley.

THIS INVENTION relates to castors.

Many mobile devices such as shopping and hospital trolleys are manoeuvrable on four such castors, usually one at each corner, and such devices are notorious for their inability in certain circumstances to permit the trolley to be steered and manoeuvred easily, particularly when heavily loaded and when it is required to direct the trolley around corners. This difficulty arises largely through the inability of the castors to rotate freely about their upright axes.

It is an object of the present invention to provide a castor with increased freedom of rotation about the upright axis on which it is mounted on the frame or chassis of the trolley.

Typically, such castors are mounted on a thrust bearing which may be subject to contamination or wear such that the relatively movable parts of the bearing assembly tend to become stiff, or excessively loose thus to become misaligned.

According to the present invention, there is provided a castor comprising a fork having a pair of lobes between which extends a transverse axle carrying at least one wheel rotatable thereon, and an upright member to which may be connected a frame or chassis of a load bearing object such as a trolley; characterised by at least one journal bearing disposed to provide rotation about an upright axis between the fork and said frame or chassis.

Preferably, the fork is freely rotatable on a first bearing with respect to a first member connected to the fork, and the first member is freely rotatable on a second bearing with respect to a second member connected to the first member, the second member being adapted for connection to a frame or chassis of a load bearing object such as a trolley.

Preferably, the first and second bearings are on aligned axes.

The castor may comprise three or more roller or ball bearings.

The first bearing may be a thrust bearing.

The first bearing may be a journal bearing.

The second bearing may be a journal bearing.

The second member may be welded to the frame or chassis.

The fork, first member and second member may be held in aligned assembly by a single central bolt or rivet.

The first member may include a bearing axially aligned with the axis of rotation of said first member.

The second member may comprise a pair of axially aligned bearings each axially aligned with the second member.

The single central bolt or rivet may be independently rotatable with respect to the fork and the second member.

Embodiments of the invention will now be described, by way of example only, with reference to the accompanying drawing, in which:—

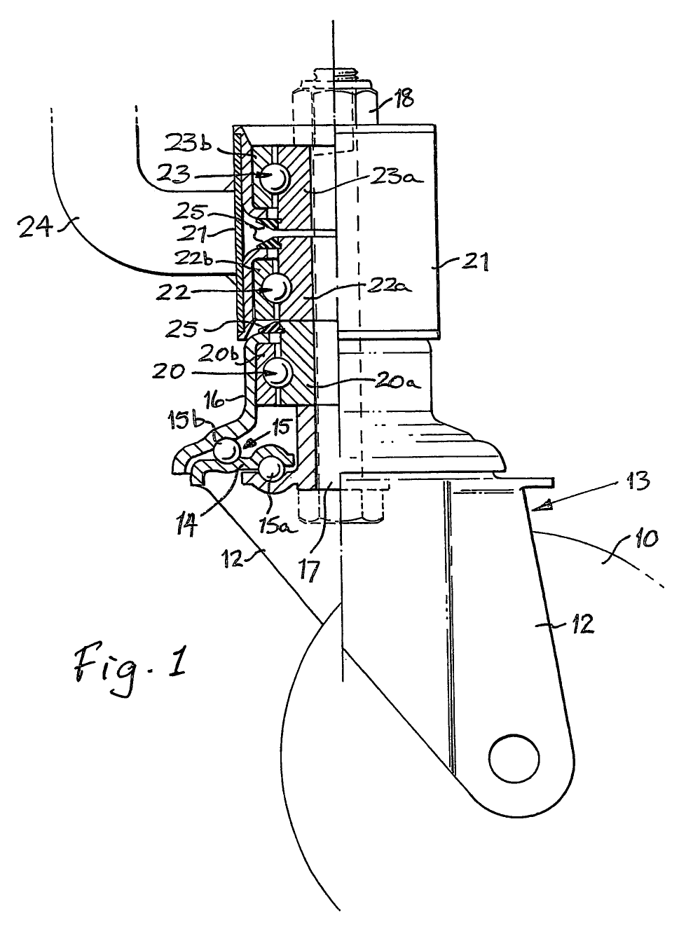

FIG. 1 is a part-sectional elevation of a castor made in accordance with a first embodiment;

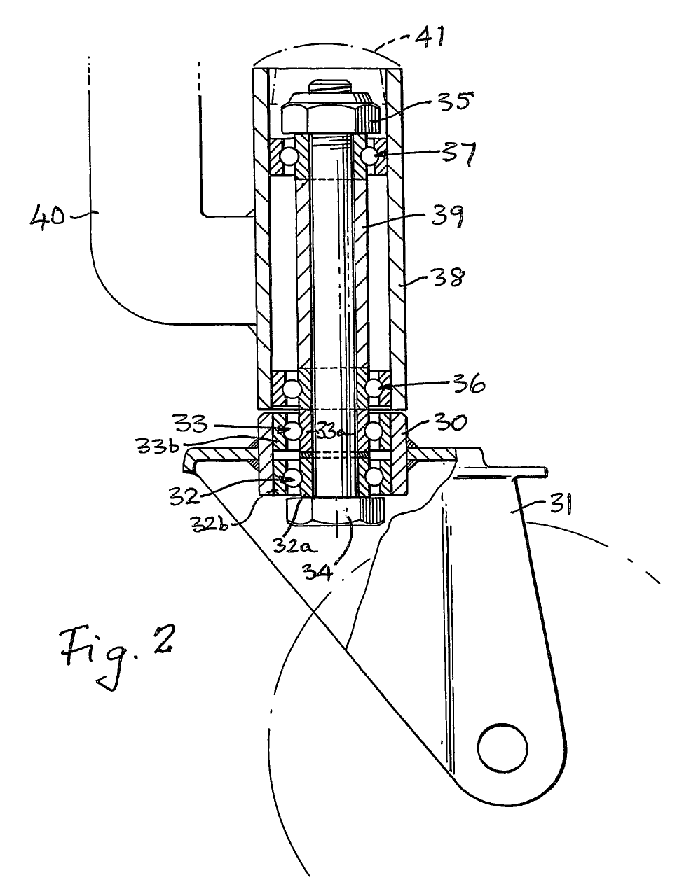

FIG. 2 is a similar view of a castor made in accordance with a second embodiment; and

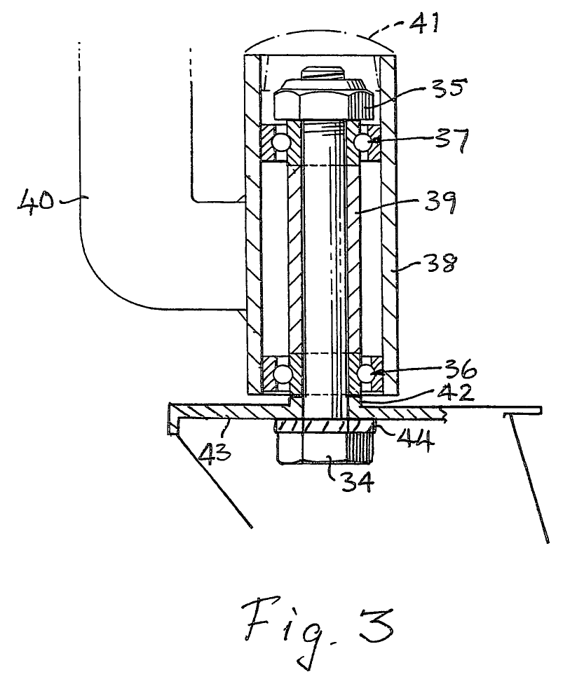

FIG. 3 is a similar view of a castor made in accordance with a third embodiment.

Referring to FIG. 1, there is provided a castor wheel 10 mounted on a transverse axle 11 extending between a pair of lobes 12 of a fork generally indicated at 13.

A cross plate 14 at the top of the fork is connected via a thrust bearing 15 having ball races 15a, 15b to a first upright member 16 by means of a bolt 17 the shaft of which extends upwardly through the entire bearing assembly to be secured by a self-locking nut 18.

By the term “thrust bearing” is meant a bearing wherein, in use, a load applied thereto is borne by the balls or rollers thereof in an axial direction with respect to the bolt 17.

Surrounding the shaft of the bolt 17 within the first upright member 16 is a first concentric ball or roller journal bearing 20 having inner and outer races 20a and 20b. Thus, the fork 13 is freely rotatable on the bearing 15 about the vertical axis of the bolt 17 with respect to the first upright member 16, and the latter is also freely rotatable on the bearing 20 about the axis of the bolt 17.

By the term “journal bearing” is meant a bearing wherein, in use, a load applied thereto is borne by the balls or rollers thereof in a radial direction with respect to the bolt 17, with or without some axial bearing direction.

Also mounted on the shaft of the bolt 17 above the first upright member 16 is a second upright member 21. This member is mounted on a pair of axially aligned ball or roller journal bearings 22 and 23 having, respectively inner and outer races 22a, 22b and 23a, 23b, such that the cylindrical wall of the second upright member 21 is freely rotatable on the bearings 22 and 23 with respect to the bolt 17, to the first upright member 16 and to the fork 13.

Welded or otherwise attached to the cylindrical wall of the second upright member 21 is a frame member 24 of a trolley or other load bearing object.

Grease seals 25 are provided on bearings 20, 22 and 23 and a dust cap (not shown) may be mounted on the top of the bearing assembly.

It will therefore be seen that the fork 13, the first upright member 16 and the second upright member 21 are all freely rotatable relative to one another thus providing entirely free rotation of the castor with respect to the frame member 24.

If required, the upright axes of rotation of the first upright member 16 and the second upright member 21 may be displaced by the interposition of a horizontal plate attached to one or other of the upright members and rotatable with respect to the other such upright member upon a thrust bearing or the like. Preferably however, all axes of rotation are aligned thus ensuring complete freedom of rotary movement of the respective parts of the assembly.

Referring to FIG. 2, the thrust bearing 15 of the aforementioned embodiment is omitted and replaced by a casing 30 fixed by welding to the top of the fork 31, and in which is located first, and second journal bearings 32 and 33 having, respectively, inner and outer races 32a, 32b, and 33a, 33b. The head of a bolt 34 bears against the bottom surface of inner race 32a and the shank passes upwardly through the entire bearing assembly to be secured by a self-locking nut 35.

Third and fourth bearings 36 and 37 located in a sleeve 38 replace the assembly of parts 22, 23 and 21 of FIG. 1. Spacers 39 support the inner races of the bearings within the assembly.

In this embodiment, therefore, the fork 31 is freely rotatable on journal bearings 32 and 33 with respect to bolt 34, as is sleeve 38 on journal bearings 36 and 37 with respect to bolt 34 and fork 31. Bolt 34 is similarly rotatable independently. Once again, a leg or frame member 40 of a trolley or other object may be attached by welding or other means, to the sleeve 38. A dust cap 41 may be fitted to the top of sleeve 38.

In the embodiments of FIGS. 1 and 2, a trolley or the like mounted on or connected to sleeve 21 or 38 is manoeuvrable on two or more bearings which interact in series to afford the castor entirely free rotational movement which does not rely on a single thrust bearing as typically found in conventional castors where movement can be inhibited by wear of the axial load-bearing races.

Considerably improved stability and free manoeuvrability are afforded by a castor made in accordance with the invention.

Referring now to FIG. 3, in a simplified bearing assembly for the castor, perhaps where only light loads are to be applied, bearings 32 and 33 in FIG. 2 may be omitted and an upstanding lip on fork 43 may bear directly against the underside of the inner race of bearing 36, with bolt head 34 tightened against a washer 44 on the underside of the fork 43.

In this example therefore the castor is mounted effectively on a single journal bearing which is the combination of bearings 36 and 37, which themselves may be replaced by a single elongated roller bearing. Thus, in this example, the conventional thrust bearing upon which castors have been mounted previously, is replaced by a journal bearing of the type wherein the load is borne by the bearings in the radial as well as the axial direction.

1. A castor comprising a fork having a pair of lobes between which extends a transverse axle carrying at least one wheel rotatable thereon, and an upright member to which may be connected a frame or chassis of a load bearing object such as a trolley; characterized by at least one journal bearing disposed to provide rotation about an upright axis between the fork and said frame or chassis.

2. A castor according to claim 1, wherein the fork is freely rotatable on the first bearing with respect to a first member connected to the fork; the first member is freely rotatable on a second bearing with respect to a second member connected to the first member; the second member being adapted for connection to a frame or chassis of a load bearing object such as a trolley.

3. A castor according to claim 2, wherein the first and second bearings are on aligned axes.

4. A castor according to claim 1, including three or more roller or ball bearings.

5. A castor according to claim 2, wherein the first bearing is a thrust bearing.

6. A castor according to claim 2, wherein the first bearing is a journal bearing.

7. A castor according to claim 2, wherein the second bearing is a journal bearing.

8. A castor according to claim 2, wherein the second member is welded to the frame or chassis.

9. A castor according to claim 2, wherein the fork, first member and second member are held in aligned assembly by a single central bolt or rivet.

10. A castor according to claim 2, wherein the first member includes a rotational bearing axially aligned with the axis of rotation of said first member.

11. A castor according to claim 2, wherein the second member comprises a pair of axially aligned rotational bearings, each being axially aligned with the second member.

12. A castor according to claim 9, wherein the single central bolt or rivet is independently rotatable with respect to the fork and the second member.
